(19) United States
(12) Patent Application Publication
(10) Pub. No.: US 2015/0259959 A1
(43) Pub. Date: Sep. 17, 2015

(54) BIAXIAL HINGE AND ELECTRONIC DEVICE

(71) Applicants: Beijing Lenovo Software Ltd., Beijing (CN); Lenovo (Beijing) Limited, Beijing (CN)

(72) Inventors: Jun Xu, Beijing (CN); Uchiyama Yoshiharu, Beijing (CN)

(21) Appl. No.: 14/490,947

(22) Filed: Sep. 19, 2014

(30) Foreign Application Priority Data
Mar. 17, 2014 (CN) 201410099264.7

(51) Int. Cl. E05D 3/02

(52) U.S. Cl. CPC E05D 3/02

(57) ABSTRACT

The present invention discloses a biaxial hinge which is used to save the space. The biaxial hinge comprises a first shaft having a first groove; a second shaft having a second groove, wherein a first axle center of a first cross section of the first shaft and a second axle center of a second cross section of the second shaft locate in a first straight line; and a floating pin for engaging with the first groove or the second groove, wherein a centre of a third cross section of the floating pin does not locate in the first straight line. The present invention further discloses an electronic device including the biaxial hinge.

### CROSS-REFERENCE TO RELATED APPLICATION

This application claims the benefit of Chinese Patent Application No. 201410099264.7 filed on Mar. 17, 2014 in the State Intellectual Property Office of China, the whole disclosure of which is incorporated herein by reference.

### BACKGROUND OF THE INVENTION

1. Field of the invention

The present invention relates to a field of machinery technology, and more particularly, to a biaxial hinge and an electronic device.

2. Description of the Related Art

In the field of machinery technology, a height of a traditional hinge is relatively large and more spaces may be occupied. Besides, it is megatrends to provide lighter, thinner and smaller electronic devices. Therefore, the traditional hinge obviously does not match the megatrends of the electronic device.

### SUMMARY OF THE INVENTION

According to these embodiments of the present invention, there are provided a biaxial hinge and an electronic device, in order for solving the technical problem that the prior art biaxial hinge occupies a relatively more space.

According to an aspect of the present invention, there provides a biaxial hinge comprising:
a first shaft having a first groove;
a second shaft having a second groove, wherein a first axle center of a first cross section of the first shaft and a second axle center of a second cross section of the second shaft locate in a first straight line; and
a floating pin for engaging with the first groove or the second groove, wherein a centre of a third cross section of the floating pin does not locate in the first straight line.

In an embodiment of the present invention, the second shaft is rotatable relative to the floating pin when the floating pin is engaged with the first groove; and, the first shaft is rotatable relative to the floating pin when the floating pin is engaged with the second groove.

In an embodiment of the present invention, a first rotation direction of the first shaft is the clockwise direction or the counter-clockwise direction, and a second rotation direction of the second shaft is the clockwise direction or the counter-clockwise direction.

In an embodiment of the present invention, the first cross section is a first circle with a first gap, and the second cross section is a second circle with a second gap.

In an embodiment of the present invention, the first cross section and the second cross section have the same area.

According to another aspect of the present invention, there provides an electronic device, comprising:
a main body and a supporter for supporting the main body, wherein the supporter comprises a biaxial hinge comprising:
   a first shaft having a first groove;
   a second shaft having a second groove, wherein a first axle center of a first cross section of the first shaft and a second axle center of a second cross section of the second shaft locate in a first straight line; and
   a floating pin for engaging with the first groove or the second groove, wherein the center of a third cross section of the floating pin does not locate in the first straight line.

In an embodiment of the present invention, the supporter locates on a first lateral portion of the main body.

In an embodiment of the present invention, the main body further comprises a second lateral portion opposing to the first lateral portion, and a thickness of the main body tends to decrease in a direction from the first lateral portion to the second lateral portion, and the supporter is located on the first lateral portion.

In an embodiment of the present invention, the main body comprises a display unit disposed in a first surface of the main body.

In an embodiment of the present invention, the supporter comprises a connecting component and a supporting component movably connected to the main body through the connecting component.

In an embodiment of the present invention, the biaxial hinge is received in the connecting component.

In an embodiment of the present invention, when the supporting component moves from a first place near the first lateral portion to a second place apart from the first lateral portion, the supporting component supports the main body.

In an embodiment of the present invention, the connecting component has a cylindrical shape.

According to these embodiments of the present invention, the floating pin can be engageable with the first groove or the second groove, the centre of the third cross section of the floating pin is located in the second straight line, and, the centre of the third cross section of the floating pin, and the first axle center of the first cross section of the first shaft and the second axle center of the second cross section of the second shaft are not located in the same straight line. In this way, the height of the whole biaxial hinge decreases and the space occupied by the biaxial hinge correspondingly decreases, thereby saving the space. Meanwhile, once the biaxial hinge is located in the electronic device, it helps to manufacture thinner and smaller electronic devices.

### BRIEF DESCRIPTION OF THE DRAWINGS

The above and other features of the present invention will become more apparent by describing in detail exemplary embodiments thereof with reference to the accompanying drawings, in which:

FIG. 1 is a structural schematic diagram of a traditional biaxial hinge;

FIG. 2 is a structural schematic diagram of a biaxial hinge according to an embodiment of the present invention;

FIG. 3 is another structural schematic diagram of a biaxial hinge according to an embodiment of the present invention;

FIG. 4 is a mainly structural schematic diagram of an electronic device according to an embodiment of the present invention; and

FIG. 5 is a detailed structural schematic diagram of an electronic device according to an embodiment of the present invention.

### DETAILED DESCRIPTION OF PREFERRED EMBODIMENTS OF THE INVENTION

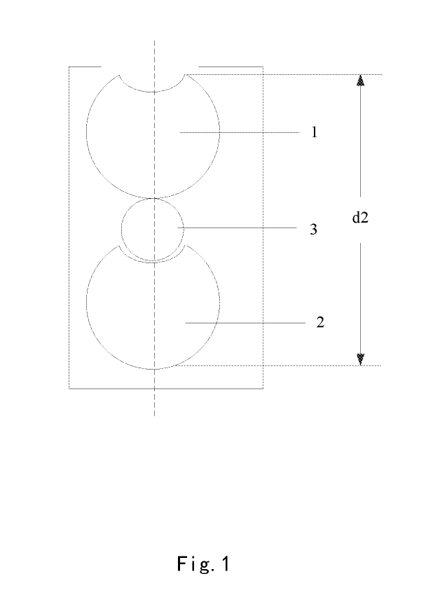

FIG. 1 shows a traditional biaxial hinge used usually in a tablet computer. Referring to FIG. 1, this biaxial hinge includes two shafts 1 and 2, and further includes a floating pin 3 located between the two shafts. And, the axle centers of the two shafts and that of the floating pin are located in one straight line. In this way, a height of a traditional hinge is relatively large and more spaces may be occupied.

According to an embodiment of the present invention, a biaxial hinge comprises: a first shaft having a first groove; a second shaft having a second groove, wherein a first axle center of a first cross section of the first shaft and a second axle center of a second cross section of the second shaft locate in a first straight line; and a floating pin for engaging with the first groove or the second groove, wherein a centre of a third cross section of the floating pin does not locate in the first straight line. Accordingly, a first height which is a height from the first shaft to the second shaft in the first straight line when the floating pin is engaged with the first groove or the second groove is smaller than a second height which is a height from the first shaft to the second shaft in the first straight line when the centre of the third cross section of the floating pin is located on the first straight line.

According to the embodiment of the present invention, the floating pin is engageable with the first groove or the second groove, the centre of the third cross section of the floating pin does not locate in the first straight line, that is, the centre of the third cross section of the floating, and the first axle center of the first cross section of the first shaft and the second axle center of the second cross section of the second shaft are not located in the same straight line. In this way, the height of the whole biaxial hinge decreases and the space occupied by the biaxial hinge correspondingly decreases, thereby saving the space. Meanwhile, once the biaxial hinge is located in the electronic device, it helps to manufacture thinner and smaller electronic devices.

Description of the exemplary embodiments of the present invention will be described clearly and fully hereinafter in detail with reference to the attached drawings, in order to provide a thorough understanding of the object, the technical solution and the advantage of the disclosed embodiments of the present invention. The present invention may, however, be embodied in many different forms and should not be construed as being limited to the embodiment set forth herein; rather, these embodiments are provided so that the present invention will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In addition, the terminology “and/or” herein only represents an association relationship between the associated objects and there are three cases of such relationship, for example, A and/or B represents only A, both A and B, and only B cases. Meanwhile, the character “/” generally represents the relationship between the associated objects is an “or” relationship.

Exemplary embodiments of the present invention will be described hereinafter in detail with reference to the attached drawings.

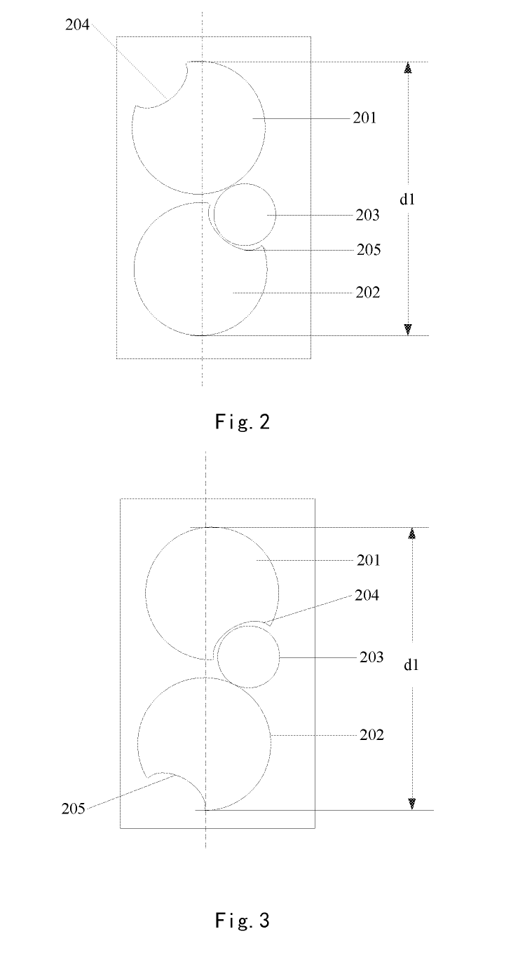

Referring to FIG. 2, a biaxial hinge is provided according to an embodiment of the present invention. The biaxial hinge may comprise a first shaft 201, a second shaft 202 and a floating pin 203.

The first shaft 201 has a first groove 204, the second shaft 202 has a second groove 205, and, a first axle center of a first cross section of the first shaft 201 and a second axle center of a second cross section of the second shaft 202 are located in one straight line, i.e., a first straight line, as the dotted line shown in FIG. 2. It can be seen from FIG. 2 that, the first cross section of the first shaft 201 is a circle having a gap, and, the second cross section of the second shaft 202 is also a circle having a gap. Preferably, the first cross section of the first shaft 201 has the same area as the second cross section of the second shaft 202.

The floating pin 203 is engageable with the first groove 204 or the second groove 205. FIG. 2 shows an example in which the floating pin 203 is engaged with the second groove 205. Further, the centre of the third cross section of the floating pin 203 is located in a second straight line, and the first straight line is different from but is paralleled with the second straight line. Herein, the centre of the third cross section of the floating pin 203 is the center of a circle of a third cross section of the floating pin 203.

A first height which is a height from the first shaft 201 to the second shaft 202 in the first straight line when the floating pin 203 is engaged with the first groove 204 or the second groove 205, as d1 shown in FIG. 2, is smaller than a second height which is a height from the first shaft 201 to the second shaft 202 in the first straight line when the centre of the third cross section of the floating pin 203 is located on the first straight line, as d2 shown in FIG. 1.

In FIGS. 1 and 2, the cross sectional areas of the first shaft 201, of the second shaft 202, and of the floating pin 203 are equidistant from one another. It can be seen obviously that, when the centre of the third cross section of the third cross section of the floating pin 203 is not located in the first straight line, the height of the whole biaxial hinge decreases and the space occupied by the biaxial hinge correspondingly decreases, thereby saving the space.

Referring to FIG. 3, in the embodiment of the present invention, the second shaft 202 is rotatable relative to the floating pin 203 when the floating pin 203 is engaged with the first groove 204. Herein, the first shaft 201 is in a fixed state without any rotation. A rotation direction of the second shaft 202 may be the clockwise direction or the counter-clockwise direction. When the second shaft 202 rotates by a first preset angle, the second groove 205 is engageable with the floating pin 203.

Continue to FIG. 2, in the embodiment of the present invention, the first shaft 201 is rotatable relative to the floating pin 203 when the floating pin 203 is engaged with the second groove 205. Herein, the second shaft 202 is in a fixed state without any rotation. A rotation direction of the first shaft 201 may be the clockwise direction or the counter-clockwise direction. When the first shaft 201 rotates by a second preset angle, the first groove 204 is engageable with the floating pin 203.

According to the embodiment of the present invention, the rotation direction of the first shaft 201 is independent of the rotation direction of the second shaft 202.

when the first groove 204 is engaged with the floating pin 203 or when the second groove 205 is engaged with the floating pin 203, there may be some slight movement for the floating pin 203 and correspondingly the first height may change slightly. However, the movement of the floating pin 203 falls within some range such that the centre of the third cross section of the third cross section of the floating pin 203 is always not located on the first straight line, that is, the first height is always smaller than the second height.

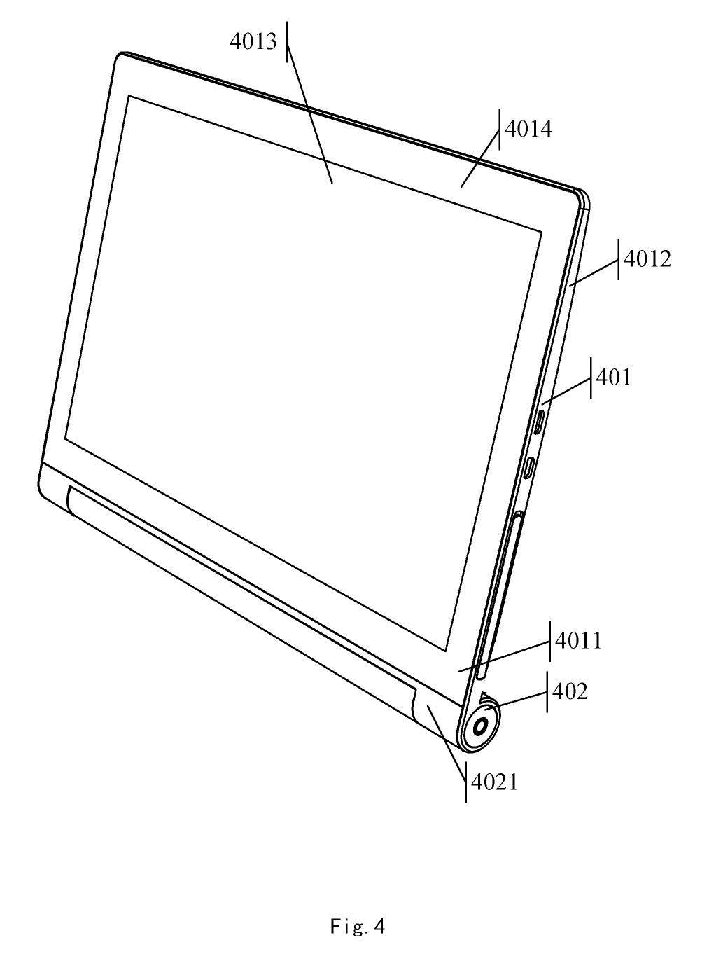

Referring to FIG. 4, an electronic device is provided according to an embodiment of the present invention. The electronic device may comprise a main body 401 and a supporter 402 for supporting the main body 401. The main body 401 and the supporter 402 may be integrated into one piece. The supporter may include a biaxial hinge abovementioned. The biaxial hinge is not shown in FIG. 4 since it is located within the supporter 402.

Preferably, in the embodiment of the present invention, the main body 401 may comprise a first lateral portion 4011 and a second lateral portion 4012 opposing to the first lateral portion 4011, and the supporter 402 locates on a first lateral portion 4011 of the main body 401. A thickness of the main body 401 tends to decrease in a direction from the first lateral portion 4011 to the second lateral portion 4012, and the supporter 402 is located on the first lateral portion 4011.

Preferably, in the embodiment of the present invention, a center of gravity of the first lateral portion 4011 may be coincided with a center of gravity of the main body 401, that is, the center of gravity of the first lateral portion 4011 and that of the main body 401 may be the same one. In this way, a center of gravity of the electronic device is correspondingly located on the first lateral portion 4011 such that the electronic device is ensured to stand much more steadily through first lateral portion 4011.

Preferably, in the embodiment of the present invention, in order to reduce the thickness of the second lateral portion 4012, at least one first functional component, such as motherboard, CPU, camera module, loudspeaker, sound card, graphics card, etc., which is disposed within the main body 401 and occupies a larger space, can be disposed within a position of the main body 401 adjacent to the first lateral portion 4011. In this way, the thickness of the main body 401 can be gradually reduced from the first lateral portion 4011 to the second lateral portion 4012, which further ensures that the thickness of the main body 401 tends to decrease in the direction from the first lateral portion 4011 to the second lateral portion 4012.

Continue to FIG. 4, in the embodiment of the present invention, preferably, the main body 401 may further comprise a display unit 4013 which can be disposed to a first surface 4014 of the main body 401.

In FIG. 4, specifically, the supporter 402 comprises a connecting component 4021 where the biaxial hinge is received.

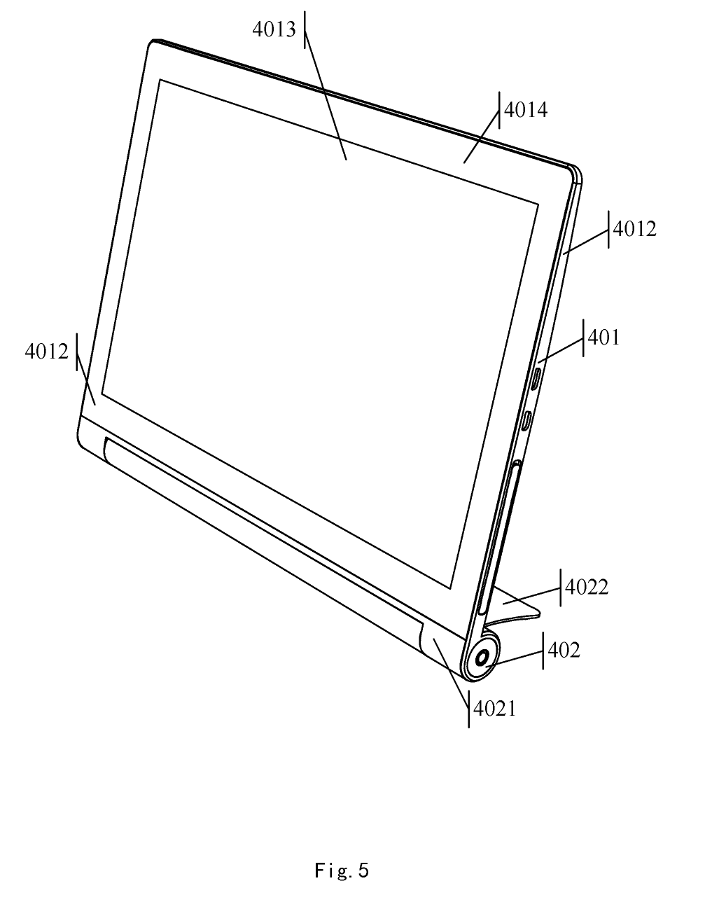

Preferably, referring to FIG. 5, in the embodiment of the present invention, in addition to the connecting component 4021, the supporter 402 can comprise a supporting component 4022.

The supporting component 4022 is movably connected to the main body 401 through the connecting component 4021. When the supporting component 4022 moves from a first place near the first lateral portion 4011 to a second place apart from the first lateral portion 4011, the supporting component 4022 supports the main body 401 and the biaxial hinge is located in the connecting component 4021. That is, the movement of the supporting component 4022 relative to the main body 401 by the connecting component 4021 is completed by the biaxial hinge.

The supporter 402 may be consisted of the connecting component 4021 and the supporting component 4022, and, the latter two components may be integrated into one piece, or, the supporting component 4022 is sleeved on the connecting component 4021 but is fixedly connected to the connecting component 4021. In other words, once the connecting component 4021 moves, the supporting component 4022 is brought to move correspondingly.

According to the embodiment of the present invention, with provision of the supporting component 4022, the electronic device can stand in a much steadier manner, which facilitates to handle by the user.

As shown in FIGS. 4 and 5, the connecting component 4021 may have a cylindrical shape.

Thus it can been, since the height of the biaxial hinge decreases, the inner diameter of the connecting component 4021 decreases correspondingly, thereby enabling to manufacture lighter, thinner and smaller electronic devices.

According to an embodiment of the present invention, there provides a biaxial hinge comprising: a first shaft 201 having a first groove 204; a second shaft 202 having a second groove 205, wherein a first axle center of a first cross section of the first shaft 201 and a second axle center of a second cross section of the second shaft 202 are located in a first straight line; and a floating pin 203 engageable with the first groove 204 or the second groove 205, wherein the centre of the third cross section of the floating pin 203 is located in a second straight line different from the first straight line, and the first straight line is paralleled with the second straight line; wherein, a first height which is a height from the first shaft 201 to the second shaft 202 in the first straight line when the floating pin 203 is engaged with the first groove 204 or the second groove 205 is smaller than a second height which is a height from the first shaft 201 to the second shaft 202 in the first straight line when the centre of the third cross section of the floating pin 203 is located on the first straight line.

According to the embodiment of the present invention, the floating pin can be engageable with the first groove or the second groove, the centre of the third cross section of the floating pin is located in the second straight line, and, the centre of the third cross section of the floating pin, and the first axle center of the first cross section of the first shaft and the second axle center of the second cross section of the second shaft are not located in the same straight line. In this way, the height of the whole biaxial hinge decreases and the space occupied by the biaxial hinge correspondingly decreases, thereby saving the space. Meanwhile, once the biaxial hinge is located in the electronic device, it helps to manufacture thinner and smaller electronic devices.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

What is claimed is:

1. A biaxial hinge, comprising:
a first shaft having a first groove;
a second shaft having a second groove, wherein a first axle center of a first cross section of the first shaft and a second axle center of a second cross section of the second shaft locate in a first straight line; and
a floating pin for engaging with the first groove or the second groove, wherein a centre of a third cross section of the floating pin does not locate in the first straight line.

2. The biaxial hinge according to claim 1, wherein the second shaft is rotatable relative to the floating pin when the floating pin is engaged with the first groove; and, the first shaft is rotatable relative to the floating pin when the floating pin is engaged with the second groove.

3. The biaxial hinge according to claim 1, wherein a first rotation direction of the first shaft is the clockwise direction or the counter-clockwise direction, and a second rotation direction of the second shaft is the clockwise direction or the counter-clockwise direction.

4. The biaxial hinge according to claim 1, wherein the first cross section is a first circle with a first gap, and the second cross section is a second circle with a second gap.

5. The biaxial hinge according to claim 1, wherein the first cross section and the second cross section have the same area.

6. An electronic device, comprising:
a main body and a supporter for supporting the main body, wherein the supporter comprises a biaxial hinge comprising:
a first shaft having a first groove;
a second shaft having a second groove, wherein a first axle center of a first cross section of the first shaft and a second axle center of a second cross section of the second shaft locate in a first straight line; and
a floating pin for engaging with the first groove or the second groove, wherein the center of a third cross section of the floating pin does not locate in the first straight line.

7. The electronic device according to claim 6, wherein the supporter locates on a first lateral portion of the main body.

8. The electronic device according to claim 7, wherein the main body further comprises a second lateral portion opposing to the first lateral portion, and a thickness of the main body tends to decrease in a direction from the first lateral portion to the second lateral portion, and the supporter is located on the first lateral portion.

9. The electronic device according to claim 8, wherein the main body comprises a display unit disposed in a first surface of the main body.

10. The electronic device according to claim 9, wherein the supporter comprises a connecting component and a supporting component movably connected to the main body through the connecting component.

11. The electronic device according to claim 10, wherein the biaxial hinge is received in the connecting component.

12. The electronic device according to claim 11, wherein when the supporting component moves from a first place near the first lateral portion to a second place apart from the first lateral portion, the supporting component supports the main body.

13. The electronic device according to claim 12, wherein the connecting component has a cylindrical shape.
